(19) United States
(12) Patent Application Publication
(10) Pub. No.: US 2016/0258691 A1
(43) Pub. Date: Sep. 8, 2016

(54) HEAT DISSIPATION MODULE

(71) Applicant: Acer Incorporated, New Taipei City (TW)

(72) Inventors: Yung-Chih Wang, New Taipei City (TW); Cheng-Wen Hsieh, New Taipei City (TW); Ting-Chiang Huang, New Taipei City (TW); Wen-Neng Liao, New Taipei City (TW)

(21) Appl. No.: 14/729,069

(22) Filed: Jun. 3, 2015

(30) Foreign Application Priority Data
Mar. 6, 2015 (TW) 104107288

(51) Int. Cl. F28D 15/02; G06F 1/20; G06F 1/16; F28F 13/00

(52) U.S. Cl. CPC F28D 15/02; F28F 13/00; G06F 1/20; G06F 1/1662; F28D 2015/0216

(57) ABSTRACT

A heat dissipation module including an evaporator, a copper tube communicated with the evaporator to construct a loop, and a heat-transmitting medium flowing in the loop is provided. The evaporator includes an upper cover and a lower cover connected with each other and constructing a cavity. The lower cover has a heat-isolating wall protruded toward the cavity, so as to separate a heat-isolating region and a heating region at the lower cover. The upper cover has a slope inclining toward the cavity. A heat of an electronic element is transmitted to the heat-transmitting medium through the heating region, so that the heat-transmitting medium flows out of the evaporator towards a single direction along the slope after absorbing the heat, flows in the copper tube to transmit the heat outward through the copper tube, and then flows back to the evaporator through the copper tube after dissipating the heat.

### CROSS-REFERENCE TO RELATED APPLICATION

This application claims the priority benefit of Taiwan application serial no. 104107288, filed on Mar. 6, 2015. The entirety of the above-mentioned patent application is hereby incorporated by reference herein and made a part of this specification.

### BACKGROUND OF THE INVENTION

1. Field of the Invention

The invention relates to a heat dissipation module, and relates particularly to a heat dissipation module of an electronic device.

2. Description of Related Art

In recent years, along with developments of the industrial technology industry, electronic devices, for example, products such as notebooks, personal digital assistants (PDA) and smart phones have become a part of our daily lives. Part of the electronic elements carried inside these electronic devices will typically generate heat during the process of operation and affect the operation effectiveness of the electronic device. Therefore, generally a heat dissipation module or a heat dissipation element, for example, a heat dissipation fan, a heat dissipation paste material or a heat dissipation pipe will be disposed inside the electronic device to help dissipating the heat generated by the electronic element to the outside of the electronic device.

In the above heat dissipation module, the heat dissipation fan may dissipate the heat to the outside effectively, however it consumes a large amount of power, is heavier, requires a larger space and is not advantageous to be used on an electronic device that pursues a light and thin design, and furthermore is susceptible to noise which affects the additional communication functions of the electronic device. In addition, in order for the heat dissipation fan to perform heat dissipation through convection, an opening is required to be disposed on the outer shell of the electronic device, which also lowers the structural strength of the electronic device. On the other hand, heat dissipation paste material absorbs heat of the electronic element lowering the surface temperature, and the cost thereof and space required is lower, and therefore may be widely used in an electronic device. However, it is difficult to further dissipate the heat to the outside through other components, limiting its heat dissipation effect. Furthermore, a heat dissipation pipe may transmit the heat of the electronic element onto another plate, however it lacks in convection and therefore the cooling effect is limited. In this way, the heat dissipation pipe may be further arranged with an evaporator and a condenser to construct a loop, and use a phase change material that may change between two phases (for example, a liquid state and a gaseous state) by suitably absorbing or releasing heat as a heat-transmitting medium, flowing and circulating in the heat dissipation pipe, to absorb heat at the evaporator and release heat at the condenser, and transmitting the heat to the outside from the electronic element. However, the heat-transmitting medium only flows in the loop through the phase change of it self, in which the flow effect is poor, thus limiting the heat dissipation effect thereof.

### SUMMARY OF THE INVENTION

The invention provides a heat dissipation module having good heat dissipation effect.

The heat dissipation module of the invention is adapted to be disposed in an electronic device, to dissipate heat of an electronic element inside the electronic device. The heat dissipation module includes an evaporator, a copper tube and a heat-transmitting medium. The evaporator includes an upper cover and a lower cover. The upper cover and the lower cover are connected with each other and construct a cavity. The lower cover has a heat-isolating wall protruded towards the cavity, so as to separate a heat-isolating region and a heating region at the lower cover, and the evaporator is connected to the electronic element through the heating region. The upper cover has a slope inclining towards the cavity, and a vertical distance between the slope and the heat-isolating region is smaller than a vertical distance between the slope and the heating region. The copper tube is communicated with the evaporator to construct a loop, and a height level of a first end of the copper tube adjacent to the heat-isolating region is lower than a height level of a second end of the copper tube adjacent to the heating region, such that the copper tube has a height difference. The heat-transmitting medium is disposed and flowing in the loop constructed by the copper tube and the evaporator, wherein a heat of the electronic element is transmitted to the heat-transmitting medium through the heating region, such that the heat-transmitting medium flows out of the evaporator towards a single direction along the slope after absorbing the heat, flows in the copper tube through the height difference of the copper tube to transmit the heat outward through the copper tube, and then flows back to the evaporator through the copper tube after dissipating the heat.

Based on the above, in the heat dissipation module of the invention, the evaporator includes an upper cover having a slope and a lower cover having a heat-isolating wall, wherein the heat-isolating wall separates a heat-isolating region and a heating region on the lower cover, and the copper tube which is communicated with the evaporator and constructs a loop has a height difference, so that the heat-transmitting medium may flow inside the loop. In this way, the heat of the electronic element may be transmitted to the heat-transmitting medium through the heating region, such that the heat-transmitting medium flows in the copper tube after absorbing the heat, and further transmits the heat outward through the copper tube. Wherein, the heat-transmitting medium flows out of the evaporator through the slope towards a single direction, and flows out of the copper tube towards a single direction through the potential energy produced by the height difference in the copper tube, and thus increasing the flow rate of the heat-transmitting medium and increasing the rate of heat dissipation. In this way, the heat dissipation module of the invention has good heat dissipation results.

The accompanying drawings are included to provide a further understanding of the invention, and are incorporated in and constitute a part of this specification. The drawings illustrate embodiments of the invention and, together with the description, serve to explain the principles of the invention.

### BRIEF DESCRIPTION OF THE DRAWINGS

FIG. 1 is a top schematic view of a heat dissipation module according to an embodiment of the invention.

FIG. 2 is a top schematic view of the heat dissipation module of FIG. 1 used in an electronic device.

FIG. 3 is an exploded view of an evaporator of FIG. 1.

FIG. 4 is a cross-sectional view of the evaporator of FIG. 3.

FIG. 5 is a partial side schematic view of the heat dissipation module of FIG. 1.

### DESCRIPTION OF THE EMBODIMENTS

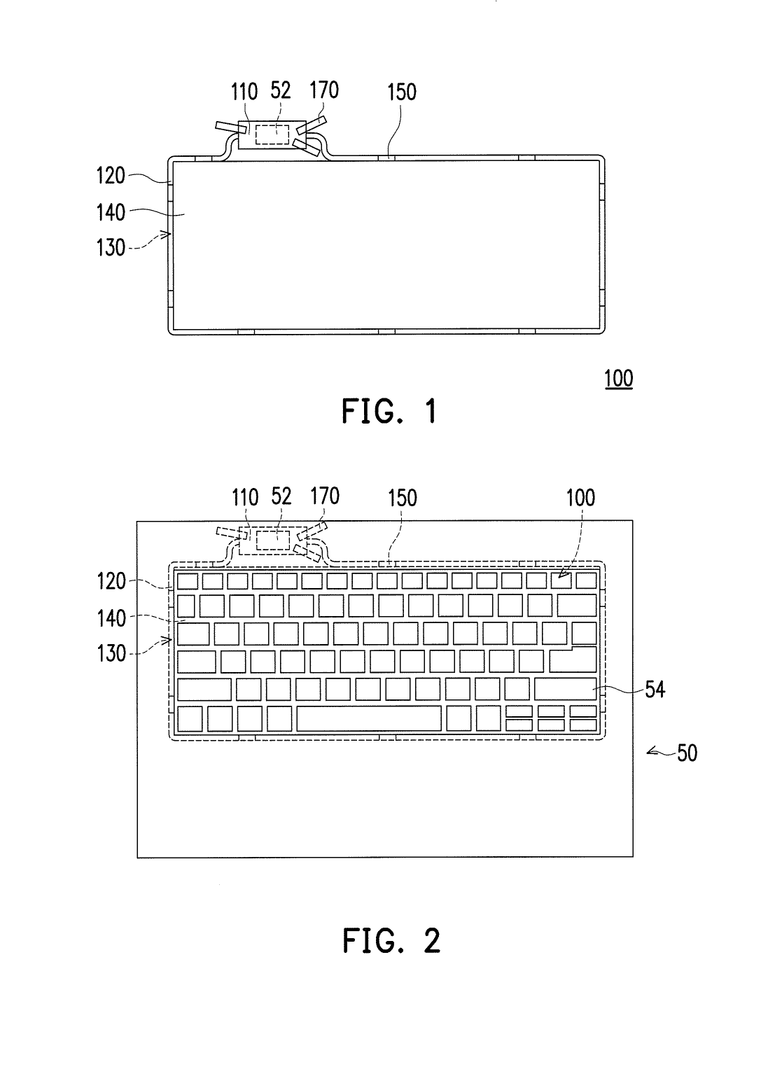

FIG. 1 is a top schematic view of a heat dissipation module according to an embodiment of the invention. FIG. 2 is a top schematic view of the heat dissipation module of FIG. 1 used in an electronic device. Referring to FIG. 1 and FIG. 2, in the present embodiment, a heat dissipation module 100 is adapted for an electronic device 50. The electronic device may be an electronic device having a single body, or also may be an electronic device having two bodies, for example, a notebook, and only one body is shown in FIG. 1; however the type of electronic device should not be construed as a limitation to the invention. An electronic element 52 such as a central processing unit (CPU) or other suitable electronic element is disposed inside the electronic device 50 to execute related operations. The electronic element 52 generates heat during the process of operation. In this way, the heat dissipation module 100 of the present embodiment is adapted to be disposed in the electronic device 50 to dissipate the heat of the electronic element 52 in the electronic device 50.

More specifically, in the present embodiment, the heat dissipation module 100 includes an evaporator 110, a copper tube 120 and a heat-transmitting medium 130. The evaporator 110 is adapted to connect with the electronic element 52. The copper tube 120 is communicated with the evaporator 110 to construct a loop (as shown in FIG. 1 and FIG. 2), and the heat-transmitting medium 130 is disposed and flowing in the loop constructed by the copper tube 120 and the evaporator 110. In this way, the heat of the electronic element 52 may be transmitted to the heat-transmitting medium 130 through the evaporator 110, such that the heat-transmitting medium 130 flows in the copper tube 120 after absorbing heat and transmits the heat outwards through the copper tube 120, and then flows back to the evaporator 110 through the copper tube 120 after dissipating the heat. In this way, the heat-transmitting medium 130 may flow in the copper tube 120 to dissipate the heat into the air through the tube walls of the copper tube 120.

In addition, in the present embodiment, the heat dissipation module 100 further includes a supporting plate 140 and a plurality of fixing clamps 150. The supporting plate 140 is disposed in the electronic device 50, and the copper tube 120 is fixed on the supporting plate 140 by the fixing clamp 150 and may be further fixed by welding, however the method of fixing should not be construed as a limitation to the invention. In this way, the heat-transmitting medium 130, not only dissipates the heat into the air through the tube walls of the copper tube 120, but also transmits the heat to the supporting plate 140 through the copper tube 120 to quickly dissipate the heat into the air through the supporting plate 140 with a larger heat dissipation area. The supporting plate 140 may carry a keyboard module 54 (shown in FIG. 2) of the electronic device 50 inside the electronic device 50, and the copper tube 120 is fixed on the supporting plate 140 and surrounds the periphery of the keyboard module 54, so as to prevent interfering with the disposing of the keyboard module 54. In other words, the present embodiment may increase the heat dissipating efficiency of the heat dissipation module 100 through the supporting plate 140 which was originally used for supporting the keyboard module 54, and another additional heat dissipation element does not need to be disposed. However, whether the supporting plate 140 is disposed or not should not be construed as a limitation to the invention, which may be adjusted according to requirements. In this way, the heat dissipation module 100 may transmit the heat of the electronic element 52 outwards through the heat-transmitting medium 130 flowing in the loop constructed by the copper tube 120 and the evaporator 110, thus achieving an objective of heat dissipation.

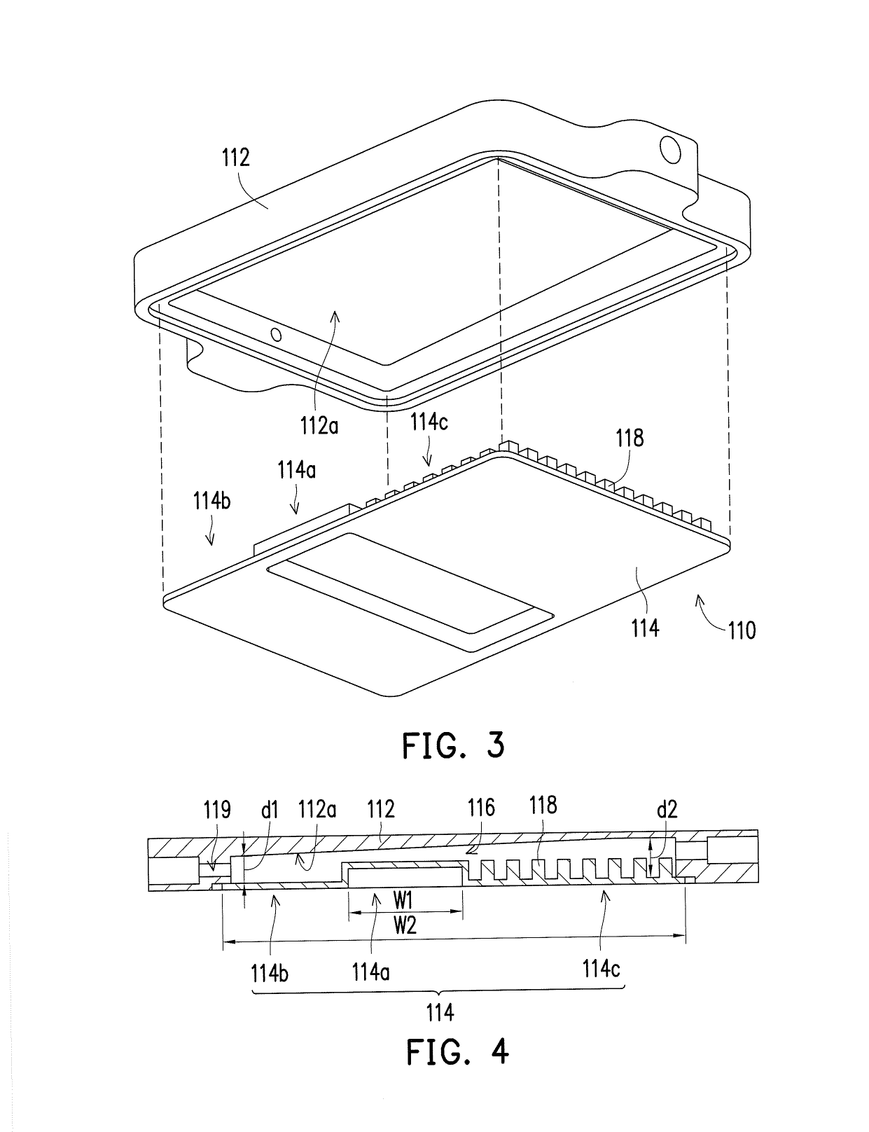

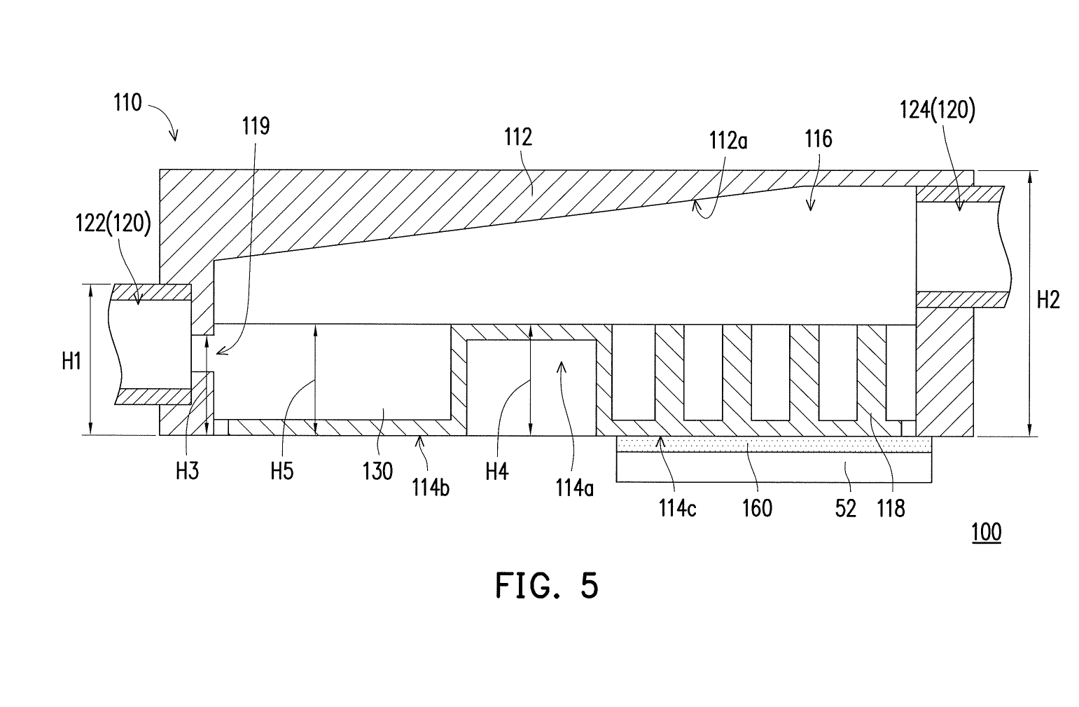

FIG. 3 is an exploded view of an evaporator of FIG. 1. FIG. 4 is a cross-sectional view of the evaporator of FIG. 3. FIG. 5 is a partial side schematic view of the heat dissipation module of FIG. 1. FIG. 5 is a partially enlarged simplified illustration of the evaporator 110, and the illustrated content is used for describing the flow process of the heat-transmitting medium 130 inside the copper tube 120 and the evaporator 110 (as a schematic) and should not be construed as a limitation for the specific structural dimensions of the heat dissipation module of the invention. In the present embodiment, the evaporator 110 of the heat dissipation module 100 has a special design, such that the heat-transmitting medium 130 circulates along a single direction in the loop constructed by the copper tube 120 and the evaporator 110, so as to increase the flow rate. When the flow rate of the heat-transmitting medium 130 in the loop increases, the rate of heat absorption in the evaporator 110 and the rate of heat dissipation in the copper tube 120 also increases. In this way, as long as the design of the heat dissipation module 100 contributes to increasing the flow rate of the heat-transmitting medium 130, the heat dissipation efficiency of the heat dissipation module 100 is able to be improved.

Referring to FIG. 3 to FIG. 5, in the present embodiment, the evaporator 110 includes an upper cover 112 and a lower cover 114. The upper cover 112 and the lower cover 114 may be of metal material, and fixed together by welding, however the invention is not limited thereto. The upper cover 112 and the lower cover 114 are connected together and construct a cavity 116. The lower cover 114 has a heat-isolating wall 114a protruded toward the cavity 116, so as to separate a heat-isolating region 114b and a heating region 114c at the lower cover 114. In other words, the protruding heat-isolating wall 114a may separate two regions (namely the heat-isolating region 114b and the heating region 114c) on the lower cover 114 which is located at two opposite sides of the heat-isolating wall 114a and may be used to store the heat-transmitting medium 130. The heat-transmitting medium 130 is distributed at the heat-isolating region 114b and the heating region 114c after flowing into the evaporator 110 from the copper tube 120, and the evaporator 110 is connected to the electronic element 52 through the heating region 114c. In addition, the evaporator 110 further includes a plurality of heating elements 118. The heating elements 118, for example, are metal protruding pillars (for example, copper pillars) with good thermal conductivity and are disposed at the heating region 114c of the lower cover 114, and protruded towards the cavity 116, so as to increase the heating area of the heating region 114c. In other words, the heating region 114c of the evaporator 110 may absorb more heat through the heating elements 118. In this way, the rate of the heat transmitted to the heat-transmitting medium 130 through the heating region 114c is increased.

Furthermore, in the present embodiment, the heat dissipation module 100 further includes a thermal conductive element 160 (shown in FIG. 5) and a plurality of elastic elements 170 (shown in FIG. 1 and FIG. 2). The thermal conductive element 160, for example, is a thermal interface material (TIM), and is disposed between the electronic element 52 and the heating region 114c, so as to fill the gap between the electronic element 52 and the heating region 114c, and help transmitting the heat of the electronic element 52 to the heating region 114c. The elastic elements 170, for example, are metal springs, and are disposed on the evaporator 110 and pressing on the electronic element 52, so as to provide pressure to make the electronic element 52, the thermal conductive element 160 and the heating region 114c in close contact. In this way, the heat generated by the electronic element 52 during the process of operation may be transmitted to the heat-transmitting medium 130 through the heating region 114c, and the transmitting efficiency may be increased by the thermal conductive element 160 and the elastic elements 170. However, whether the thermal conductive element 160 and the elastic elements 170 are used or not should not be construed as a limitation to the invention and may be adjusted according to requirements.

In addition, in the present embodiment, the thermal conductivity of the heat-isolating wall 114a is lower than the thermal conductivity of the other parts of the lower cover 114. Wherein, the heat-isolating wall 114a, for example, is another component manufactured from a heat-isolating material and fixed on the lower cover 114, in this way lowering the thermal conductivity thereof. Or, the heat-isolating wall 114a also may be a protruding structure constructed by a part on the lower cover 114, and then covering the surface of the heat-isolating wall 114a facing the cavity 116 with a thermal conductive material, in this way lowering the thermal conductivity thereof. However, in other embodiments not shown, the heat-isolating wall may also be a structure integrally formed with the lower cover 114 and protruding in towards the cavity 116, and does not have a material different to the lower cover 114. The composition of the heat-isolating wall 114a and the thermal conductivity thereof should not be construed as a limitation to the invention. Preferably, a width W1 of the heat-isolating wall 114a is greater than ⅓ of a width W2 of the lower cover 114. In this way, the heat-isolating wall 114a may effectively lower the heat transmitted to the heat-isolating region 114b from the heating region 114c. In other words, due to the barrier of the heat-isolating wall 114a, the heat of the electronic element 52 is not easily transmitted to the heat-isolating region 114b; therefore the heat absorbed by the heat-transmitting medium 130 located at the heating region 114c is greater than the heat absorbed by the heat-transmitting medium 130 located at the heat-isolating region 114b.

On the other hand, in the present embodiment, the upper cover 112 has a slope 112a inclining towards the cavity 116. The lateral range of the slope 112a corresponds to the heat-isolating region 114b, the heat-isolating wall 114a and the heating region 114c, and a vertical distance d1 between the slope 112a and the heat-isolating region 114b is smaller than a vertical distance d2 between the slope 112a and the heating region 114c. In other words, when the heat-isolating region 114b and the heating region 114c of the lower cover 114 are located at the same plane level, a height level of a side of the slope 112a corresponding to the heat-isolating region 114b is lower than a height level of another side of the slope 112a corresponding to the heating region 114c, such that the volume of the cavity 116 corresponding to the heating region 114c is larger. In this way, the heat of the electronic element 52 is transmitted to the heat-transmitting medium 130 through the heating region 114c, such that the heat-transmitting medium 130 flows along the slope 112a from the side with a lower height level towards the side with a higher height level after absorbing the heat, and then flows out of the evaporator 110. In other words, through the design of the slope 112a, the heat-transmitting medium 130 may flow out of the evaporator 110 towards a single direction along the slope 112a after absorbing the heat in the heating region 114c, in this way increasing the flow rate of the heat-transmitting medium 130.

Furthermore, in the present embodiment, the copper tube 120 has a first end 122 and a second end 124 opposite to each other. The copper tube 120 is connected to the heat-isolating region 114b by the first end 122, and connected to the heating region 114c by the second end 124, thus constructing a closed loop, such that the heat-transmitting medium 130 may flow in the loop and pass through the evaporator 110 and the copper tube 120 in sequence. Wherein, a height level H1 of the first end 122 of the copper tube 120 adjacent to the heat-isolating region 114b is lower than a height level H2 (shown in FIG. 5) of the second end 124 of the copper tube 120 adjacent to the heating region 114c, such that the copper tube 120 has a height difference. In this way, the heat of the electronic element 52 is transmitted to the heat-transmitting medium 130 through the heating region 114c, such that the heat-transmitting medium 130 flows out of the evaporator 110 in a single direction along the slope 112a after absorbing the heat, flows in the copper tube 120 through the height difference of the copper tube 120 to transmit the heat outwards through the copper tube 120, and then flows back to the evaporator 110 through the copper tube 120 after dissipating the heat, so as to complete one heat dissipation circulation.

More specifically, in the present embodiment, the loop constructed by the copper tube 120 and the evaporator 110 is rendered in a vacuum state, so as to lower the boiling point of the heat-transmitting medium 130, such that the heat-transmitting medium 130 may produce a phase change in the loop by the heat. The heat-transmitting medium 130 is, for example, water or coolant, however the invention is not limited thereto. The heat-transmitting medium 130 may absorb heat in the evaporator 110 and dissipate the heat by flowing in the copper tube 120, and the heat-transmitting medium 130 may produce a phase change when absorbing or dissipating the heat. More specifically, the heat-transmitting medium 130 produces a phase change from a liquid state to a gaseous state after absorbing heat in the evaporator 110. Wherein, the heat absorbed by the heat-transmitting medium 130 located at the heating region 114c is greater than the heat absorbed by the heat-transmitting medium 130 located at the heat-isolating region 114b, such that it is easier for the heat-transmitting medium 130 located at the heating region 114c to produce a phase change to a gaseous state. In addition, the heating region 114c corresponds to the side of the slope 112a having a higher height level, and the second end 124 of the copper tube 120 corresponds to the heating region 114c. In this way, it is easier for the heat-transmitting medium 130 which changed to a gaseous state to flow out of the evaporator 110 along the slope 112a towards the side having a higher height level, and further flow into the copper tube 120 from the second end 124. In this way, the heat-transmitting medium 130 in the evaporator 110 flows into the copper tube 120 through the second end 124 along the slope 112a towards a single direction after changing to a gaseous state.

Furthermore, in the present embodiment, due to the copper tube 120 having a height difference, it is easier for the heat-transmitting medium 130 to spontaneously flow from the second end 124 which is adjacent to the heating region 114c and has a higher height level H2 to the first end 122 which is adjacent to the heat-isolating region 114b and has a lower height level H1 through potential energy. The heat-transmitting medium 130 flows inside the copper tube 120 and dissipates the heat into the air through the copper tube 120, or further transmits the heat outwards to the supporting plate 140 to dissipate into the air. The heat-transmitting medium 130 produces a phase change from a gaseous state changing to a liquid state after dissipating the heat, and then flows to the evaporator 110 again from the first end 122 through the copper tube 120. In this way, the heat-transmitting medium 130 which changed to a liquid state absorbs the heat in the evaporator 110 that is transmitted to the heating region 114c from the electronic element 52 again and changes to a gaseous state, and flows into the copper tube 120 again along the slope 112a from the second end 124 having a higher height level H2 and corresponding to the heating region 114c after changing to a gaseous state, and then flows in the copper tube 120 by the height difference of the copper tube 120 and transmits the heat outwards through the copper tube 120. In this way, the above process continues such that the heat-transmitting medium 130 flows in the loop constructed by the evaporator 110 and the copper tube 120, namely the heat of the electronic element 52 may be continuously dissipated into the air, achieving an objective of heat dissipation.

Furthermore, because the heat-transmitting medium 130 flows along a single direction, namely the heat-transmitting medium 130 flows into the evaporator 110 from the first end 122 of the copper tube 120 and flows out of the evaporator 110 from the second end 124 of the copper tube 120, therefore the heat-transmitting medium 130 first flows into the heat-isolating region 114b, and then spills over the heat-isolating region 114b and the heat-isolating wall 114a and flows into the heating region 114c. In addition, in the present embodiment, the heat-isolating wall 114a has a micro-structure not shown, for example, a powder, net or trench structure, so as to transmit the heat-transmitting medium 130 located at the heat-isolating region 114b to the heating region 114c, however the micro-structure may also be a smooth surface, and it should not be construed as a limitation to the invention. In this way, when the liquid level of the heat-transmitting medium 130 located at the heat-isolating region 114b does not exceed the height level of the heat-isolating wall 114a, and the heat-transmitting medium 130 is unable to flow into the heating region 114c by the above process, the heat-transmitting medium 130 in a liquid state may still be transmitted to the heating region 114c through the capillary effect between the heat-transmitting medium 130 and the micro-structure located on the heat-isolating wall 114a. In other words, disposing the micro-structure on the heat-isolating wall 114a helps continuously supply the heat-transmitting medium 130 in a liquid state to the heating region 114c from the heat-isolating region 114b, to increase the circulation capability of the heat-transmitting medium 130.

In order to enhance the characteristics of the heat-transmitting medium 130 flowing in the loop constructed by the evaporator 110 and the copper tube 120 along a single direction, in the present embodiment, a height level H3 of a liquid inlet 119 between the first end 122 of the copper tube 120 adjacent to the heat-isolating region 114b and the evaporator 110 is lower than a height level H4 of the heat-isolating wall 114a. In this way, after the heat-transmitting medium 130 which changed to a liquid state by dissipating the heat flows into the evaporator 110 through the first end 122 of the copper tube 120 adjacent to the heat-isolating region 114b and distributes at the heat-isolating region 114b and the heating region 114c, the heat-isolating wall 114a may effectively block the heat transmitted to the heating region 114c from the electronic element 52 from being further transmitted to the heat-isolating region 114b, such that it is easier for the heat-transmitting medium 130 at the heating region 114c to absorb the heat and produce a phase change to a gaseous state, and flow out of the evaporator 110 along the slope 112a and flow into the copper tube 120 from the second end 124.

Similarly, in the present embodiment, the height level H3 of the liquid inlet 119 between the first end 122 of the copper tube 120 adjacent to the heat-isolating region 114b and the evaporator 110 is lower than a liquid level H5 of the heat-transmitting medium 130 at the heat-isolating region 114b. In other words, after the heat-transmitting medium 130 which changed to a liquid state by dissipating the heat flows into the evaporator 110 through the first end 122 of the copper tube 120 adjacent to the heat-isolating region 114b and distributes at the heat-isolating region 114b and the heating region 114c, the heat-transmitting medium 130 located at the heat-isolating region 114b and maintained in a liquid state covers the liquid inlet 119, such that the heat-transmitting medium 130 which has absorbed the heat in the evaporator 110 and changed to a gaseous state will not flow to the first end 122 of the copper tube 120 from the liquid inlet 119 in reverse direction, and then flow to the second end 124 of the copper tube 120 along the slope 112a. The above design helps to enhance the characteristics of the heat-transmitting medium 130 flowing in the loop constructed by the evaporator 110 and the copper tube 120 along a single direction. As long as the flow rate of the heat-transmitting medium 130 in the loop is increased effectively, the heat dissipation effect of the heat dissipation module 100 also increases as well. In this way, the heat dissipation module 100 of the present embodiment has good heat dissipation results.

In summary, in the heat dissipation module of the invention, the evaporator includes an upper cover having a slope and a lower cover having a heat-isolating wall, wherein the heat-isolating wall separates a heat-isolating region and a heating region on the lower cover, and the vertical distance between the slope and the heat-isolating region is smaller than the vertical distance between the slope and the heating region. Furthermore, the copper tube which is communicated with the evaporator and constructs a loop has a height difference, and the heat-transmitting medium may flow inside the loop. In this way, the heat of the electronic element may be transmitted to the heat-transmitting medium through the heating region, such that the heat-transmitting medium flows in the copper tube after absorbing the heat, and further transmits the heat outward through the copper tube. Wherein, the heat-transmitting medium flows out of the evaporator through the slope towards a single direction, and flows out of the copper tube towards a single direction through the potential energy produced by the height difference in the copper tube, and thus increasing the flow rate of the heat-transmitting medium and increasing the rate of heat dissipation. In this way, the heat dissipation module of the invention has good heat dissipation results.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A heat dissipation module, adapted to be disposed in an electronic device, to dissipate heat of an electronic element inside the electronic device, the heat dissipation module comprising:
an evaporator, comprising an upper cover and a lower cover, the upper cover and the lower cover are connected with each other and constructing a cavity, the lower cover having a heat-isolating wall protruded towards the cavity, so as to separate a heat-isolating region and a heating region at the lower cover, and the evaporator is connected to the electronic element through the heating region, the upper cover having a slope inclining towards the cavity, and a vertical distance between the slope and the heat-isolating region is smaller than a vertical distance between the slope and the heating region;
a copper tube, communicated with the evaporator to construct a loop, and a height level of a first end of the copper tube adjacent to the heat-isolating region is lower than a height level of a second end of the copper tube adjacent to the heating region, such that the copper tube has a height difference; and
a heat-transmitting medium, disposed and flowing in the loop constructed by the copper tube and the evaporator, wherein a heat of the electronic element is transmitted to the heat-transmitting medium through the heating region, such that the heat-transmitting medium flows out of the evaporator towards a single direction along the slope after absorbing the heat, flows in the copper tube through the height difference of the copper tube to transmit the heat outward through the copper tube, and then flows back to the evaporator through the copper tube after dissipating the heat.

2. The heat dissipation module as claimed in claim 1, wherein the heat-transmitting medium produces a phase change from a liquid state to a gaseous state after absorbing the heat in the evaporator, flows out of the evaporator along the slope, and then produces a phase change from a gaseous state to a liquid state after flowing in the copper tube and transmitting the heat outwards.

3. The heat dissipation module as claimed in claim 1, wherein the evaporator comprises a plurality of heating elements, disposed at the heating region of the lower cover, and protruded towards the cavity, so as to increase the heating area of the heating region.

4. The heat dissipation module as claimed in claim 1, wherein a height level of a liquid inlet between the first end of the copper tube adjacent to the heat-isolating region and the evaporator is lower than a height level of the heat-isolating wall.

5. The heat dissipation module as claimed in claim 1, wherein a height level of a liquid inlet between the first end of the copper tube adjacent to the heat-isolating region and the evaporator is lower than a liquid level of the heat-transmitting medium at the heating region.

6. The heat dissipation module as claimed in claim 1, wherein a width of the heat-isolating wall is greater than ⅓ of a width of the lower cover.

7. The heat dissipation module as claimed in claim 1, wherein the heat-isolating wall has a micro-structure, so as to transmit the heat-transmitting medium located at the heat-isolating region to the heating region.

8. The heat dissipation module as claimed in claim 1, wherein a thermal conductivity of the heat-isolating wall is lower than a thermal conductivity of other parts of the lower cover.

9. The heat dissipation module as claimed in claim 1, further comprising:
a supporting plate, disposed in the electronic device, in which the copper tube is fixed on the supporting plate, such that the heat-transmitting medium transmits the heat to the supporting plate through the copper tube.

10. The heat dissipation module as claimed in claim 9, wherein the supporting plate carries a keyboard module of the electronic device, and the copper tube is fixed on the supporting plate and surrounds the periphery of the keyboard module.
